(19) United States
(12) Patent Application Publication
(10) Pub. No.: US 2004/0203934 A1
(43) Pub. Date: Oct. 14, 2004

(54) Multicast paging in a communications system

(76) Inventors: Bo Kvarnstrom, Linkoping (SE); John Gunnar Mikael Olsson, Linkoping (SE); Anders Erling Andersson, Linkoping (SE); Per Johan Schultz, Linkoping (SE)

Correspondence Address: JENKENS & GILCHRIST, PC, 1445 ROSS AVENUE, SUITE 3200, DALLAS, TX, 75202, US

(21) Appl. No.: 10/240,991

(22) PCT Filed: Apr. 11, 2001
(86) PCT No.: PCT/EP01/04184

(30) Foreign Application Priority Data
Apr. 14, 2000 (GB) 0009388.0

(51) Int. Cl. H04Q 7/20

(52) U.S. Cl. 455/458; 455/422.1

(57) ABSTRACT

A cellular radio communications network uses multicast messages for transmitting page requests over the network. Thus, a single message is sent from a paging gateway to a group of addressed base stations, which respond by transmitting paging messages over the air interface. The multicast group for receiving page requests may include all base stations, in which case the base stations must be capable of determining whether they are specifically addressed, and should respond by transmitting a paging message.

### TECHNICAL FIELD OF THE INVENTION

This invention relates to a mobile communications system, and in particular to the sending of paging messages in such a system.

### BACKGROUND OF THE INVENTION

Conventional mobile telephony systems require the use of paging to find mobile stations within a network area. For example, when an incoming call is to be sent to a mobile station in a cellular network, it is necessary to locate the mobile station, so that a traffic channel can be allocated in the appropriate cell.

Typically, this involves finding the last location of the mobile station which was known to the network, and broadcasting a paging message which the mobile station can detect. The paging message can be broadcast to a single cell, to a location area, which may cover one or more cells, or to a coverage area, which may include one or more location areas.

For example, in the GSM system, paging is defined in section 08.08 of the specification. Similar methods exist in essentially all cellular telephony systems.

It will be appreciated that, since by definition the location of the mobile station is not known when paging occurs, paging messages may need to be transmitted from several base stations in their respective cells. Paging messages are therefore originated at a central point in the network, for example in the mobile services switching centre (MSC). A paging message is then sent from the MSC to the base station controller (BSC), where it is analysed, and then distributed to the respective addressed base stations.

Thus, each page can require the transmission of many messages from the BSC. In the case of a network topology which is based on the internet protocol (IP), all messages which share a common path are competing for the available bandwidth. Thus, at the BSC, for example, the transmission of many paging messages reduces the bandwidth which is available for other types of message.

### SUMMARY OF THE INVENTION

The present invention is concerned with reducing the bandwidth which is required to handle the paging messages which may be necessary to locate a mobile station within a network.

In particular, the invention concerns the use of multicast messages to transmit paging messages within the network. Thus, for example, a single multicast paging message can be sent in respect of each required page, thereby reducing the bandwidth required to carry such messages.

Preferably, multicast groups, that is, groups of addressees that will respond to specific messages, are defined. Each message can then be addressed to an appropriate group. For example, a multicast group can be defined in respect of each cell in a location area, or each cell covered by a BSC.

In a preferred embodiment, when a base station has unused capacity on its paging channel, it transmits paging messages which were not addressed to it. This has the advantage that the unused capacity can be used to increase the probability of a successful page.

### BRIEF DESCRIPTION OF DRAWINGS

FIG. 1 shows a part of a cellular telephone network in accordance with the invention.

FIG. 2 is a flow chart showing a first method in accordance with the invention.

FIG. 3 is a flow chart showing a second method in accordance with the invention.

FIG. 4 is a flow chart showing a third method in accordance with the invention.

FIG. 5 is a flow chart showing a fourth method in accordance with the invention.

FIG. 6 shows a part of a second cellular telephone network in accordance with the invention.

### DETAILED DESCRIPTION OF PREFERRED EMBODIMENTS

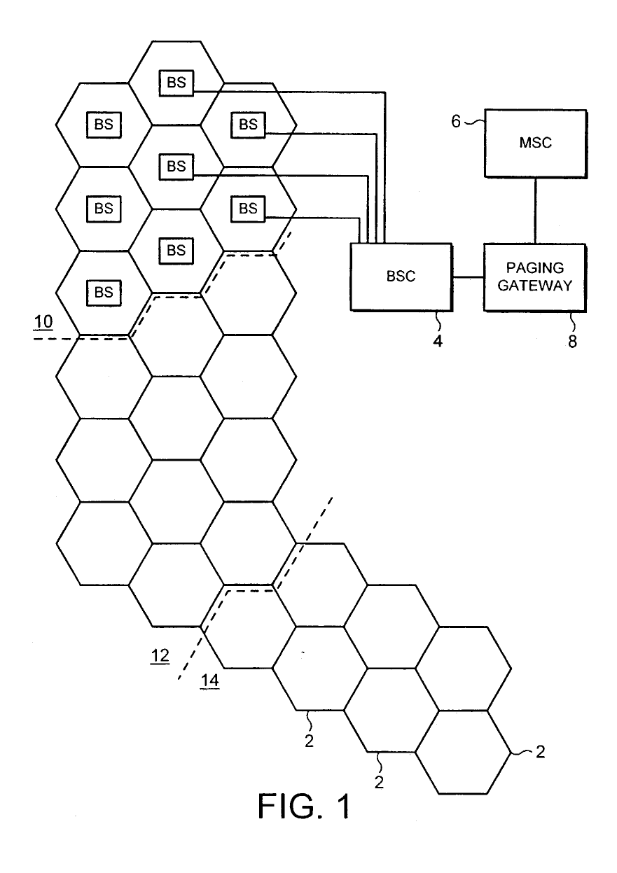

FIG. 1 is a schematic diagram of a part of a typical GSM cellular radiotelephone network infrastructure in accordance with the invention.

The illustrated network includes a large number of cells 2, only some of which are shown in FIG. 1. Each cell contains a respective base station BS, with an antenna, for communication with mobile stations within the cell. Again, only some of the base stations are shown in FIG. 1. Each base station BS has a respective landline connection to a base station controller (BSC) 4.

It will be appreciated that radio telecommunications networks can take many forms, and that the invention is applicable more widely than to the specific form of network illustrated in FIG. 1.

A mobile services switching centre (MSC) 6 is connected to the BSC 4, and is in control of the network.

In accordance with the invention, the network also includes a paging gateway 8, which handles the distribution of paging messages, as will be described in more detail below.

The paging gateway 8 is shown as an entirely separate entity located between the BSC 4 and MSC 6, but the functionality of the paging gateway could be included in either the BSC or MSC.

In this preferred embodiment, paging messages are originated in the paging gateway 8, although as mentioned previously, this can form part of the BSC or MSC. Having the paging gateway between the MSC and BSC means that the paging gateway frees the BSC from involvement in paging, and the use of multicast messages means that the resultant number of messages through the BSC is minimised.

For the purposes of paging, the network defines a number of location areas, of which FIG. 1 shows parts of three location areas 10, 12, 14, which are shown separated by dashed lines. The operation of the location areas will be described in more detail below.

As is known, when a call to a mobile station is originated, a paging message is sent to that mobile station. Specifically, a message is transmitted over the air interface in some selected number of cells, in which it is thought that the mobile station may be located. The selected cells are preferably chosen with some knowledge of the recent location of the mobile station. If the mobile station detects the paging message, it responds thereto, and the call can be set up.

The invention relies on the use of multicast messaging between the network and the base stations, to reduce the total number of messages being transmitted, for example through the base station controller. A multicast message is a message which is sent over a network to any desired number of receivers in the network. Each receiver can belong to one or more multicast groups, and the membership of the multicast groups can be assigned on configuration of the system, but can be altered dynamically.

In a preferred embodiment of the invention, there is a respective multicast group which corresponds to each of the defined location areas in the network. Thus every cell in a location area is a member of the corresponding multicast group. There is another multicast group which corresponds to each of the base station controllers in the network. Thus every cell is a member of the multicast group corresponding to its base station controller.

When a paging message is to be sent, a determination is made as to the desired extent of the paging message. This will depend on the information available about the location of the mobile station.

As a result of this determination about the desired extent of the paging message, a paging message can be sent from the paging gateway 8 to the base station in a single cell. Alternatively, a single multicast paging message can be sent from the paging gateway to every cell in a location area. Further alternatively, a single multicast paging message can be sent from the paging gateway to every cell covered by a BSC.

Thus, the extent of the paging message can be controlled as desired, although it is necessary that the gateway has knowledge of the addresses of each cell and multicast group.

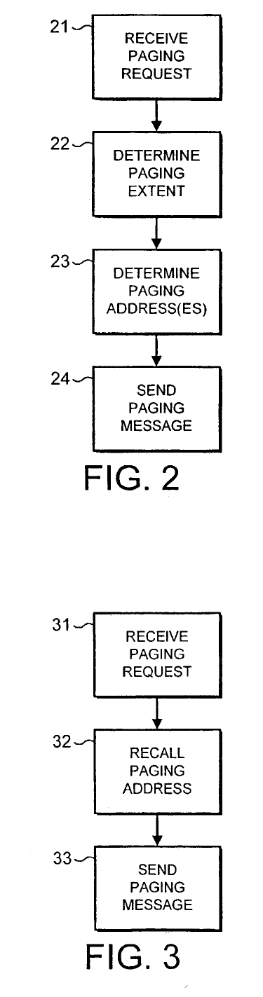

FIG. 2 is a flow chart showing the procedure carried out in the paging gateway 8 in implementing this embodiment of the invention.

In step 21, the paging gateway receives a paging request from the MSC. The paging request includes the identity of the subscriber to be paged, an indication of the paging sub-channel which is to be used, and the cells in which the page must be issued. In step 22, the paging gateway determines the required extent of the paging message. As mentioned above, this information is contained in the request from the MSC, although this determination may be made entirely by the paging gateway. In step 23, the paging gateway determines the addresses of the cells and/or groups to which the message is to be sent, and, in step 24, it sends the paging message.

Thus, where a message is to be sent to every cell in a multicast group, only one multicast message needs to be sent.

In an alternative preferred embodiment of the invention, there is defined a single multicast group for paging purposes, and every base station belongs to that multicast group.

FIG. 3 shows the simplified procedure carried out by the paging gateway in that case. In step 31, the paging gateway receives a paging request from the MSC. As described above, all paging messages are sent to the single multicast group which includes all base stations, so the paging gateway only needs to know that one address, which it recalls in step 32, and, in step 33, it sends the paging message.

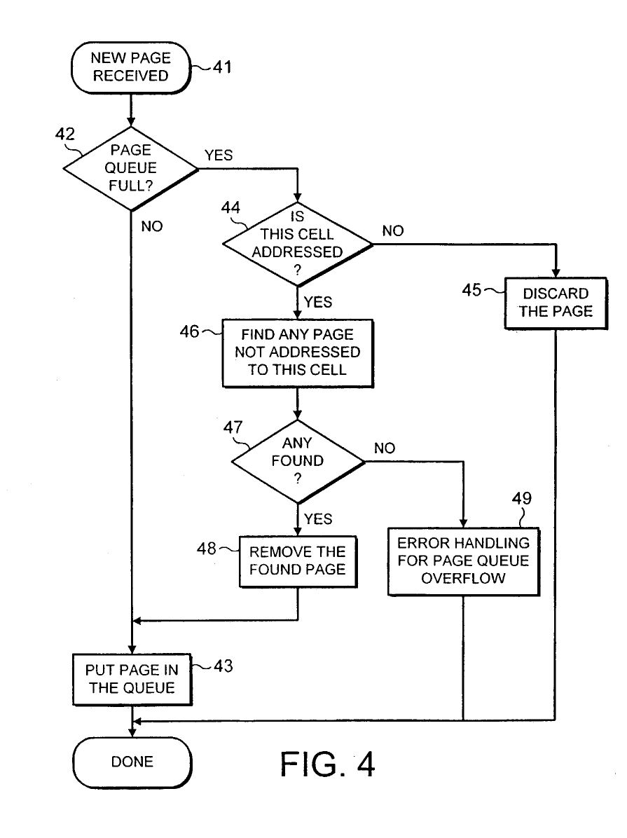

FIG. 4 is a flow chart showing the procedure carried out by the base stations when the paging gateway is carrying out the simplified procedure of FIG. 3. Although the paging gateway requires less knowledge, as described above, the base stations require more knowledge. Specifically, each base station needs to know which cell, location area and BSC it belongs to, so that it knows which of the received paging messages are addressed to it.

At step 41, the base station receives a new page message, and, at step 42, determines whether its page queue is full. That is, it determines whether it has capacity for a message on its paging channel. If the queue is not full then the message is put in the queue (step 43) in any event, and the procedure ends.

If the page queue is full, the base station determines in step 44 whether it is one of the cells addressed by the page. If the answer is no, the procedure passes to step 45, and the page is discarded. If at step 44 it is determined that the cell is addressed by the page, the procedure passes to step 46. In step 46, the system searches for a page in the queue which was not addressed to the base station, that is, a page inserted into the queue by an iteration of step 43. In step 47 it is tested whether such a page is found and, if so, the procedure passes to step 48, in which that found page is discarded, and then to step 43, in which the newly arrived page is inserted in the queue. If, on the other hand, no such page is found in step 47, that is, the page queue is already full of messages addressed specifically to that base station, an error situation is considered to have occurred, step 49.

Thus, in this case, only one message still passes through the BSC, thereby freeing BSC resources for other purposes. However, the total number of paging messages transmitted over the air interface is maximised, thereby ensuring that the base station paging channels are fully utilised, and increasing the probability that a given page will locate the intended mobile station.

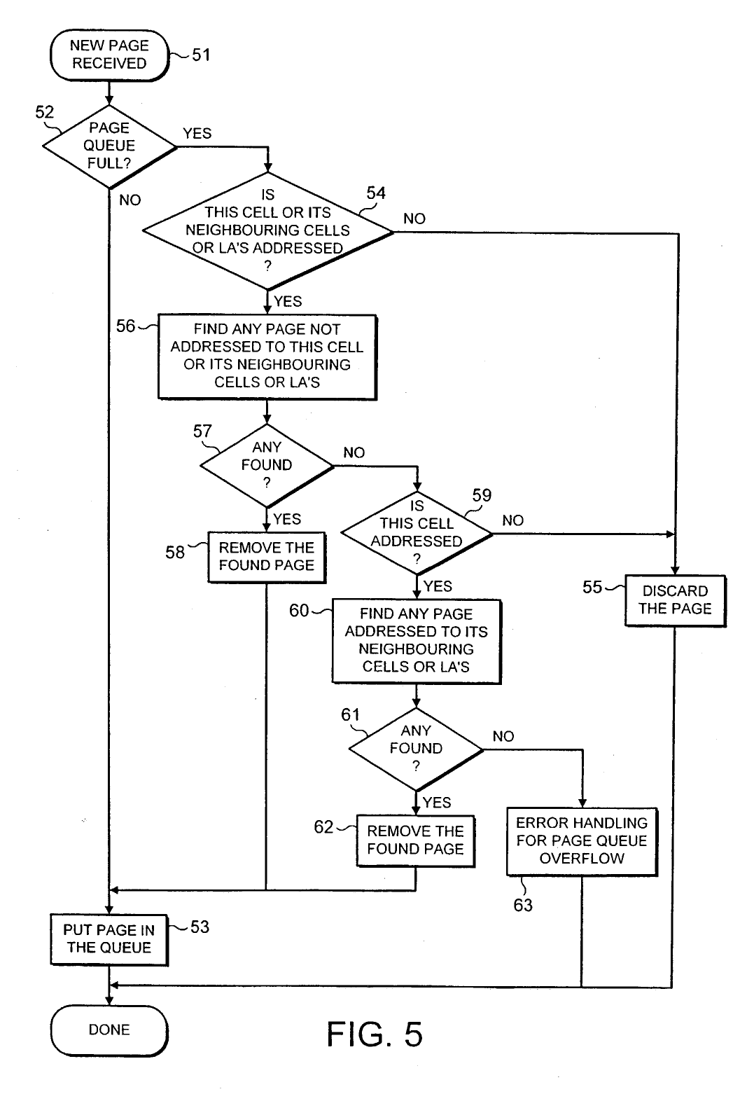

FIG. 5 is a flow chart showing an alternative procedure carried out by the base stations when the paging gateway is carrying out the simplified procedure of FIG. 3. In this case, the base stations require still more knowledge. Specifically, they need to know the neighbouring cells and neighbouring location areas to the cell and location area it belongs to.

At step S1, the base station receives a new page message, and, at step 52, determines whether its page queue is full. That is, it determines whether it has capacity for a message on its paging channel. If the queue is not full then the message is put in the queue (step 53) in any event, and the procedure ends.

If the page queue is full, the base station determines in step 54 whether it is one of the cells addressed by the page, or whether one of its neighbouring cells is addressed, or whether a cell in a neighbouring location area is addressed. If the answer is no, the procedure passes to step 55, and the page is discarded. If at step 54 it is determined that the cell is addressed by the page, or that one of its neighbouring cells is addressed, or that a cell in a neighbouring location area is addressed, the procedure passes to step 56. In step 56, the system searches for a page in the queue which does not fall into the categories tested in step 54.

In step 57 it is tested whether such a page is found and, if so, the procedure passes to step 58, in which that found page is discarded, and then to step 53, in which the newly arrived page is inserted in the page queue.

If on the other hand step 57 fails to find a page in the queue, the procedure passes to step 59, in which the base station determines whether it is one of the cells addressed by the page. If the answer is no, the procedure passes to step 55, and the page is discarded.

If at step 59 it is determined that the cell is addressed by the page, the procedure passes to step 60, in which it searches in the page queue for a page addressed only to one of its neighbouring cells, or to a cell in a neighbouring location area.

In step 61 it is tested whether such a page is found and, if so, the procedure passes to step 62, in which that found page is discarded, and then to step 53, in which the newly arrived page is inserted in the queue. If, on the other hand, no such page is found in step 61, that is, the page queue is already full of messages addressed specifically to that base station, an error situation is considered to have occurred, step 63.

Thus, in this case, received page messages are prioritised. The highest priority is given to pages specifically addressed to the cell, including those pages which are addressed to all cells in the location area or BSC to which the cell belongs. The next priority is given to messages addressed to neighbouring cells or cells in neighbouring location areas, and the lowest priority to other messages. This further increases the probability that a given page will locate the intended mobile station.

A possible further alternative procedure for the base stations is that each incoming page is first tested to determine whether the page is specifically addressed to the cell, including by way of its location area or BSC. If not, the page is discarded.

The procedures described above with reference to FIGS. 4 and 5 can also be implemented by base stations in a network in which not all base stations are capable of such operation. In that case, messages for base stations which cannot handle multicast operation must continue to be sent through the respective base station controllers. The BSC must therefore receive multicast messages sent from the paging gateway intended for such base stations.

The invention has been described above with reference to its use in a GSM network, which is used primarily for voice calls. However, it will be apparent that the invention is equally applicable to any mobile communications network. For example, the invention is applicable to a General Packet Radio System (GPRS) network, which transmits packet data signals. In such a network, a location area can be subdivided into routing areas.

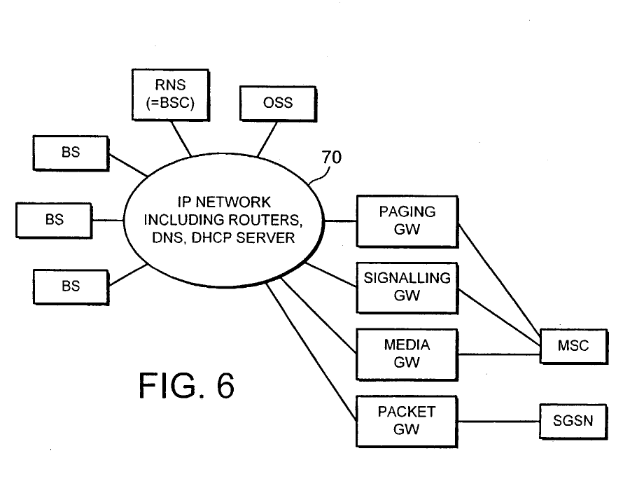

FIG. 6 is a schematic representation of a partially packet-based network, operating using the Internet Protocol (IP). The illustrated network includes a large number of cells, which are not specifically shown in FIG. 6. Each cell contains a respective base station BS, for communication with mobile stations within the cell. Of course, only a few of the base stations BS are shown in FIG. 6. Each base station BS is connected to an Internet Protocol (IP) based communications network 70.

Each base station is under the control of a Radio Network Server RNS, which is equivalent to a base station controller (BSC). Also connected to the network is an Operation & Support System OSS.

A mobile services switching centre MSC is connected to the network 70, and controls the operation of the network through a signalling gateway and a media gateway. Packet data is transmitted through a packet gateway to a Serving GPRS Service Node (SGSN), as is known.

In accordance with the invention, the mobile services switching centre MSC is also connected to the network 70 through a paging gateway, in the same way as described above with reference to the network of FIG. 1.

As before, although the paging gateway is shown as a separate entity, its functionality could be included in any other convenient network node.

Thus, the invention is applicable to any type of network, not only those illustrated.

It will be noted that the networks of the present invention allow the operation of the paging system to be tested easily. Specifically, a particular device can be dynamically assigned to one or more multicast groups, and can then monitor receipt of paging messages sent to that group.

There are therefore described networks, and methods of operation thereof, in which the efficiency of paging, compared to the required amount of network traffic, can be optimised.

1. A method of transmitting a paging message in a cellular communications network infrastructure comprising a plurality of base stations, the method comprising transmitting a single multicast message over the network infrastructure, such that a group of said base stations respond thereto by transmitting a paging message over an air interface.

2. A method as claimed in claim 1, comprising defining a single multicast group for all paging messages.

3. A method as claimed in claim 1, wherein the network infrastructure comprises a plurality of base station controllers, the method comprising defining one multicast group corresponding to each base station controller.

4. A method as claimed in claim 1, comprising defining one multicast group corresponding to each location area in the network.

5. A method of issuing paging messages over an air interface from a base station in a cellular radio communications network, the method comprising:
receiving a multicast paging message over the network infrastructure; and
issuing a corresponding paging message over the air interface.

6. A method as claimed in claim 5, wherein the base station has information about a cell in which it is located, the method comprising:
determining whether a received multicast paging message is specifically addressed thereto; and, if so issuing a corresponding paging message over the air interface.

7. A method as claimed in claim 6, the method further comprising:
determining whether a received multicast paging message is addressed to a neighbouring cell or a neighbouring location area of a cell in which the base station is located; and, if so
issuing a corresponding paging message over the air interface.

8. A method as claimed in claim 5, further comprising issuing a paging message over the air interface corresponding to a received multicast paging message, even if the received multicast paging message is not specifically addressed thereto, if a paging channel of said base station has capacity therefor.

9. A method as claimed in claim 8, comprising issuing a paging message over the air interface, corresponding to a received multicast paging message which is addressed to a neighbouring cell or a neighbouring location area of a cell in which the base station is located, in preference to a received multicast paging message which is not so addressed.

10. A method of testing a cellular radio communications network infrastructure, the method comprising dynamically allocating a test device to a multicast paging group, and monitoring paging messages received thereby.

11. A cellular communications network infrastructure comprising a plurality of base stations, at least one base station controller, and a mobile services switching centre, and further comprising a paging gateway, adapted to transmit a single multicast message to a group of said base stations, such that base stations in the group respond thereto by transmitting a paging message over an air interface.

12. A cellular communications network infrastructure as claimed in claim 11, wherein the paging gateway is located between the base station controller and the mobile services switching centre.

13. A cellular communications network infrastructure as claimed in claim 11, wherein the network is IP-based.

14. A base station for use in a cellular radio communications network, the base station comprising:
means for receiving a multicast paging message over a network infrastructure; and
being adapted to issue a corresponding paging message over an air interface.

15. A base station as claimed in claim 14, wherein the base station has information about a cell in which it is located, the base station comprising:
means for determining whether a received multicast paging message is specifically addressed thereto; and, if so
being adapted to issue a corresponding paging message over the air interface.

16. A base station as claimed in claim 14, further comprising:
means for determining whether a received multicast paging message is addressed to a neighbouring cell or a neighbouring location area of a cell in which the base station is located; and, if so
being adapted to issue a corresponding paging message over the air interface.

17. A base station as claimed in claim 14, further being adapted to issue a paging message over the air interface corresponding to a received multicast paging message, even if the received multicast paging message is not specifically addressed thereto, if a paging channel of said base station has capacity therefor.

18. A base station as claimed in claim 17, further being adapted to issue a paging message over the air interface, corresponding to a received multicast paging message which is addressed to a neighbouring cell or a neighbouring location area of a cell in which the base station is located, in preference to a received multicast paging message which is not so addressed.
